(19) United States
(12) Patent Application Publication
(10) Pub. No.: US 2002/0059848 A1
(43) Pub. Date: May 23, 2002

(54) Steering device for a motor vehicle

(76) Inventor: Heinz-Dieter Adomeit, Berlin (DE)

Correspondence Address: Michael D. Kaminski, FOLEY & LARDNER, Washington Harbour, 3000 K Street, N.W., Suite 500, Washington, DC, 20007-5109, US

(21) Appl. No.: 09/988,749

(22) Filed: Nov. 20, 2001

(30) Foreign Application Priority Data
Nov. 23, 2000 (DE) 100 59 928.1

(51) Int. Cl. B62D 1/20

(52) U.S. Cl. 74/498

(57) ABSTRACT

An apparatus for steering a motor vehicle that includes a steering control device which rotates on an axis and is designed for operation by an occupant of the vehicle. the apparatus includes a transmission mechanism for translating the rotational movement of the steering control device into a movement of an elongate steering element arranged outside the axis of rotation of the steering control device. The apparatus also includes an elongate mount which defines the axis of rotation of the steering control and which is fastened to a fixed structure of the motor vehicle. The mount is configured to be shortened or tilt downward in the event of an impact by a vehicle occupant against the steering control device.

### BACKGROUND

The present invention relates to a steering device that includes a steering control, which is pivoted on an axis and is designed for operation by an occupant of the vehicle, especially in the form of a steering wheel; a transmission arrangement, by means of which a rotational movement of the steering control can be translated into a movement of an elongate steering element (for example, a steering spindle) arranged outside the axis of rotation;

together with an elongate mount, which defines the axis of rotation of the steering control and which is fastened to a fixed structure of the motor vehicle.

The elongate steering element is here taken to mean a steering element which extends from the steering control to the track rods of the relevant vehicle, where it is coupled to the so-called steering gear. Steering shafts and steering spindles, in particular, are used as elongate steering elements. In the present case, however, the actual design of the elongate steering element is of no importance (with regard to the so-called “drive by wire”, for instance).

A fixed structure of the vehicle is taken to mean a component or sub-assembly of the vehicle, which in its spatial position is unaffected by operation of the steering device. It therefore does not move together with a moveable element of the steering device, such as the steering control (steering wheel) or the elongate steering element (steering spindle), for example.

Steering devices of the type are disclosed, for example by DE 21 31 902 A1, DE 21 36 593 A1 and DE 89 05 457 U1 (all incorporated by reference herein).

In such steering devices the mount, which is generally designed as support column, defines an axis of rotation for the steering wheel, the steering wheel being pivoted by its hub on the support column. The support column itself is fixed and can therefore serve for the fixed mounting of other functional assemblies of a motor vehicle, such as a safety device (airbag module) or electrical units or control elements, for example.

In addition, DE 30 07 726 C2 and FR 2 633 239 A3 (both incorporated by reference herein) disclose steering devices with a fixed central sub-assembly, in which the steering wheel is in each case axially displaceable and rake-adjustable for adopting a position comfortable for the respective driver.

The object of the invention is to further improve a steering device of the type described above.

### SUMMARY OF THE INVENTION

According to the present invention an apparatus or device for steering a motor vehicle is provide. The device includes a steering control or steering device that is rotatable about an axis of rotation and is configured to be operated by an occupant of the vehicle. The apparatus further includes a transmission arrangement or mechanism for transferring the rotational movement of the steering control to a steering element positioned away from the axis of rotation of the steering control.

According to the present invention, the apparatus includes a mount for supporting the steering control. The mount includes at least one element, which in the event of an impact by a vehicle occupant against the steering control causes shortening and/or tilting of the mount. This is taken to mean any element, which in the event of an impact by a vehicle occupant against the steering control facilitates a defined shortening of the elongate mount along its longitudinal axis and/or a defined tilting of the mount in a predetermined direction.

The shortening of the mount distances it from the impinging vehicle occupant.

Through a specific tilting of the mount the steering control (steering wheel) and a safety device (airbag module) regularly arranged in the area of the steering control can be purposely brought into a defined position in relation to the body of the impinging vehicle occupant. The biomechanical interaction of the body of the occupant with the steering control and possibly the safety device can thereby be optimized. In particular, it is possible to achieve a parallel movement of the body of the occupant on the one hand and a deploying airbag of an airbag module on the other.

Owing to the eccentric arrangement of the steering control in relation to the longitudinal axis of the steering element, the longitudinal axis of the steering element and a transmission element supported thereon can at the same time define a pivot point, about which the mount and hence the steering control tilts, as represented in more detail below in the explanation of preferred embodiments of the invention.

The shortening of the mount need not necessarily result in an adjustment of the absolute length of the mount (due, for example, to compression or telescoping). It is also feasible for the mount to be shifted away from the vehicle occupant; with a constant, actual length of the mount, this leads to a shortening of its effective length, that is the length measured from the point at which the mount was originally connected to the structure fixed to the vehicle (prior to displacement).

The mount is preferably tilted in such a way that, in relation to the state of the steering device as installed in a vehicle, in the event of a frontal impact of a vehicle occupant against the steering control, the mount tilts downwards so that the end section of the mount facing the steering control extends essentially parallel to the longitudinal direction of the vehicle, and so that a steering wheel supported on this mount extends with its steering wheel rim in a plane essentially perpendicular to the longitudinal direction of the vehicle. The plane defined by the steering wheel rim thereby lies essentially parallel to the plane of the upper body of an impinging occupant.

Tilting of the mount can be achieved, in that at least one section of the mount is capable of swiveling about an axis. Alternatively, the mount may be deformable, and in particular bendable, for performing the tilting movement.

In order to ensure adequate deformability of the mount for this purpose, it may have weakened areas, especially in the form of notches, which are arranged and formed so as to define a preferred direction of the tilting movement.

For the shortening of the mount, it may be of compressible design. The mount may include weakened areas, which permit a defined compression of the mount by an impinging occupant.

According to another embodiment, the mount is of telescopic design, it being possible, in particular, to provide a hydraulic or pneumatic telescopic device, so that the mount is capable of telescoping against the action of a fluid.

The mount is preferably formed by a column, which has an end section (where necessary angled for adaptation to the spatial conditions in the area of the steering wheel), which forms the axis of rotation of the steering control.

At its end section facing the steering control, the mount preferably has at least one fixed sub-assembly, to which a non-steering function attaches, for example as a safety device (in the form of an airbag module) and/or as an electrical unit or electrical operating device for other functional assemblies (audio system, horn, etc.) of a motor vehicle.

The fixed arrangement of the safety device in the form of an airbag module in the area of the steering control, in which the positioning of the airbag module is unaffected in operation of the steering control, means that the airbag module, by means of an asymmetrical design in relation to the axis of the steering control, can be specifically optimized with a view to an optimum protection of a vehicle occupant, even in a so-called out-of-position (OOP) situation (in which the corresponding vehicle occupant is situated outside their normal seated position, too close to the steering control). The apparatus may include provisions for an asymmetric folding of the inflatable airbag contained in the airbag module. Since the position of the airbag module is unaffected in operation of the steering control, the airbag module and hence also the airbag arranged in the airbag module always remains in the required position in relation to the corresponding vehicle occupant.

For immovable fixing of the mount, the mount may be fixed, for example, to a steering column cladding enclosing the steering element or to a cross-member running in the area of the dashboard.

The transmission arrangement, which serves to translate a rotational movement of the steering control into a movement of the associated steering element, may be designed, for example, as toothed gearing. It may also consist, however, of an endless member, especially in the form of a chain or a toothed belt, which is coupled on the driving side to the steering control and on the driven side to the elongate steering element. In any event, the coupling between the steering control and the elongate steering element must be designed in such a way that it does not prevent a tilting or shortening of the mount and an associated movement of the steering control relative to the elongate steering element. In the case of a toothed gearing this can be achieved, for example, in that the corresponding toothed gear elements are deformable by the forces occurring in the event of a crash, in such a way that the gears on the steering control side and those on the steering element side disengage. By contrast, a belt or chain mechanism can be arranged in such a way that the belt or the chain slips off the assigned driving and/or driven elements under the effect of the crash forces.

The support column is preferably arranged in such a way in relation to the elongate steering element that in the event of an impact of a vehicle occupant the steering control tilts about a transmission element of the transmission arrangement arranged on the longitudinal axis of the elongate steering element, the transmission arrangement acting as a lever, which extends from the longitudinal axis of the elongate steering element to the axis of rotation of the steering control.

The transmission arrangement is furthermore designed in such a way that transmission elements of the transmission arrangement on the steering control side and on the steering element side can be ultimately disengaged by the forces acting on the steering device in the event of an impact of a vehicle occupant (for example, through a belt slipping off or deformation of toothed gear elements), so as not to prevent the desired deformation or movement of the mount.

If the transmission arrangement is arranged at least partially in a housing, this is preferably destroyed in the tilting or shortening of the mount. This is intended to ensure that the housing does not oppose a movement of the mount relative to the steering element. For this purpose the housing may be provided with weakened areas, which may be predefined breaking points, for example.

The mount, the steering control and the transmission arrangement may be combined into one pre-assembled module using a suitable accommodation for the transmission arrangement, the module being mounted as a whole on a conventional steering element in the form of a steering spindle or steering shaft. The module may also be incorporated into an additional sub-assembly fixed to the mount, such as an airbag module and/or operating devices for electrical units in a motor vehicle.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 shows a side view of a first embodiment of a steering device with a steering spindle arranged outside the axis of rotation of the steering wheel and with a separate support column for the rotatable mounting of the steering wheel;

FIG. 2 shows a side view of an alternative embodiment of a steering device according to the present invention.

### DETAILED DESCRIPTION

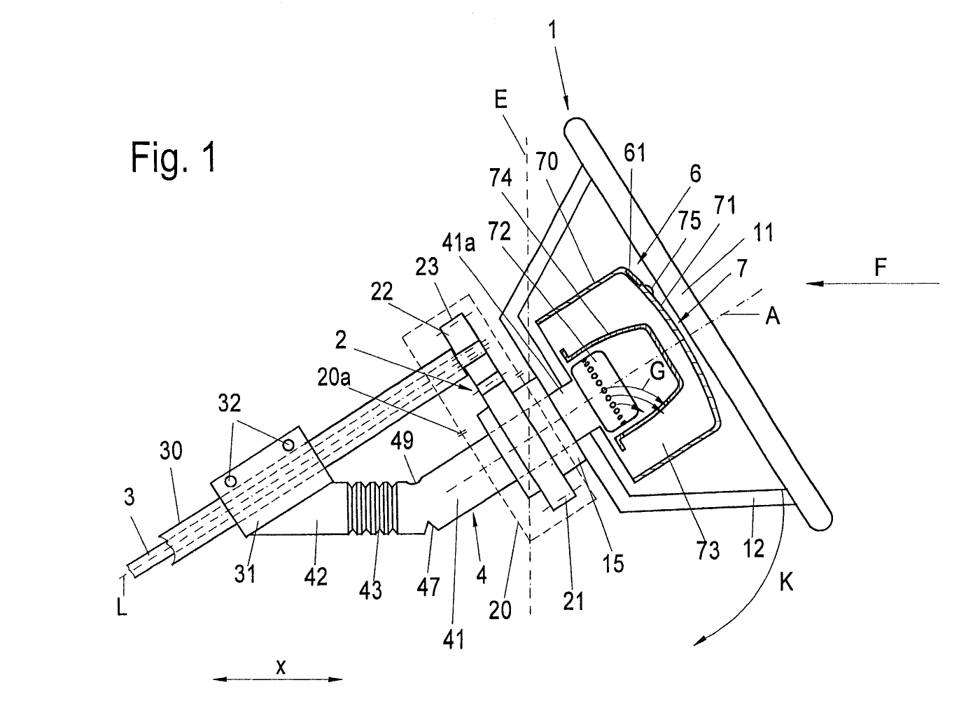

FIG. 1 represents a steering device for a motor vehicle with a steering control in the form of a steering wheel 1. The steering wheel 1 has a steering wheel rim 11 and spokes 12, which extend from the steering wheel rim 11 to a steering wheel hub 15. The hub 15 is pivoted on an end section 41a of a support column 4, which thereby defines an axis of rotation A of the steering wheel 1.

An elongate steering element in the form of a steering shaft or steering spindle 3, by means of which a rotational movement of the steering wheel 1 and hence of the steering wheel hub 15 can be transmitted to a steering gear and ultimately to the track rod of a motor vehicle, is pivoted outside the axis of rotation A.

A transmission arrangement or mechanism 2 is provided for coupling the steering wheel hub 15 to the steering shaft or steering spindle 3. The arrangement comprises an external toothing 21 arranged on the circumference of the steering wheel hub 15, together with a gear 22, concentrically connected and rotationally fixed to the steering wheel spindle 3, the external toothing 23 of which gear meshes with the external toothing 21 of the steering wheel hub 15. A rotational movement of the steering wheel hub 15 about the axis of rotation A of the steering wheel 1 is thereby translated directly into a rotational movement of the steering spindle about its longitudinal axis L.

A housing 20 may be provided to protect the transmission arrangement 2. The wall of the housing 2 may be provided with weakened areas in the form of predefined breaking points 20a, which permit a destruction or damage of the housing under the effect of a defined external force. The steering spindle 3 is furthermore surrounded by a steering column tube 30, which is immovably fixed in the relevant motor vehicle (that is to say it does not turn with the steering spindle 3) and on which a sleeve 31 is fastened by means of suitable fasteners 32. The sleeve 31 at the same time forms the end of the support column 4 remote from the steering wheel 1 and the steering wheel hub 15.

The support column is therefore fixed to a component (steering column tube 30), secured to the vehicle, by the sleeve 31.

The support column 4 extends from the sleeve 31 to an end section 41a, which on the one hand defines an axis of rotation of the steering wheel hub 15 and hence of the steering wheel 1, and on the other hand serves for the fixed (non-rotatable) accommodation of an additional sub-assembly 6.

The end section 41 a at the same time forms the steering wheel-end of a first section 41 of the support column 4, which is aligned parallel to the axis of rotation A of the steering wheel 1. This first section 41 of the support column 4 extends outwards at an angle from a second section 42 which extends from the first section of the support column 4 to the sleeve 31 on the steering column tube 30. The additional sub-assembly 6, fixed to the steering wheel-end section 41a of the support column 4, comprises in particular an airbag module 7 with a housing 70, a cover 71, a gas generator 72 and an airbag 73 that can be inflated by the gas generator 72. In the event of a strong vehicle deceleration caused by a crash and detectable by a suitable sensor, the airbag 73 is automatically inflated by means of the gas generator 72 and in so doing opens the cover 71 of the airbag module 7, so that it can deploy out of its housing 70, in order to form a protective cushion for a vehicle occupant seated behind the steering wheel.

Since the airbag module 7 is firmly arranged in the area surrounded by the steering wheel rim 11, it can be specifically optimized with a view to an optimal crash behavior, also taking particular account of so-called out-of-position (OOP) situations, in which the driver at the instant of vehicle deceleration is situated outside their normal seated position, very close to the steering wheel. Such an optimization of the airbag module 7 always requires an asymmetrical design of major parts of the module, such as the housing 70, the cover 71, the gas generator 72 and the folding of the airbag 73, cf. DE 199 27 024 A1. The spatially fixed position of the airbag module 7 (not turning with the steering wheel 1) ensures that the advantages of an asymmetrical design of the component parts of the airbag module, optimized to take account of the body shape of a vehicle occupant in a crash, are always retained regardless of the current angular position of the steering wheel 1. For the airbag module 7 is firmly arranged between the steering wheel rim 11 and therefore always remains in its original position fixed by the fastening to the support column 4, regardless of the current steering angle.

Through a suitable design of the housing 70, cover 71, gas generator 72 and airbag 73 it can be ensured, in particular, that in an OOP situation, detectable by means of a suitable sensor 75, the airbag preferably initially deploys in the lower area of the airbag module 7 facing the thighs of a vehicle occupant. For this purpose, provision can be made for the gas flow G to be initially directed by means of a diffuser 74 into the lower area of the airbag module 7, cf. the arrows G shown in FIG. 1, which run in the lower area of the airbag module 7. In an OOP situation this prevents the airbag as it deploys during inflation, from already exerting excessive pressure on the upper body or head of an occupant at an early stage, cf. DE 199 27 024 A1. Instead the deployment initially occurs in the area of the lower part of the body and the thighs of a vehicle occupant, the filling and deployment of those sections of the airbag 73 assigned to the chest and head area of the occupant (driver) being delayed until subsequently.

In addition to the airbag module 7 the additional sub-assembly 6 may also have electrical operating devices 61 (switches) for electrical units of the motor vehicle, such as an audio system or horn, for example, together with electrical instruments, in the form of display devices, for example.

A special feature of the steering device represented in FIG. 1 resides in the fact that in a crash-induced interaction with an occupant, who impinges frontally against the steering wheel 1 or the deploying airbag 73, the support column 4 shortens in a defined manner and also tilts. This shortening or tilting may be already initiated by the recoil action of the deploying airbag 73.

In the exemplary embodiment of FIG. 1, the shortening of the support column 4 is achieved in that in its second sleeve end-section 42, which runs essentially in the vehicle longitudinal direction x, the support column 4 has a weakened area 43, which causes a compression of the support column 4 due to the force F occurring in the interaction with an occupant. The weakened area 43 is therefore designed as a deformation area, which permits a compression and hence a shortening of the support column 4.

In order to permit a defined tilting of the steering wheel-end, first section 41 of the support column 4 and hence also of the steering wheel 1 and the additional sub-assembly 6 with the airbag module 7 in a pre-determinable direction K, the support column 4, in the area of the transition from the first section 41 to the second section 42, has a notch 47 and an expansion-compression area 47 arranged opposite the notch 47, which is formed by an especially expandable and compressible section of material. This combination of a notch 47 with an expansion-compression area means that in a frontal impact of an occupant against the steering wheel 1 or the airbag 73 deploying out of the module 7, the first section 41 of the support column tilts in such a way that the steering wheel rim 11 extends in a plane lying essentially perpendicular to the vehicle longitudinal direction x. In other words, the steering wheel rim 11, which is initially situated in a plane running obliquely to the vehicle longitudinal direction x, tilts into a plane that lies essentially perpendicular to the vehicle longitudinal direction x.

Owing to the arrangement of the axis of rotation A of the steering wheel 1 outside the longitudinal axis L of the steering spindle 3, the tilting of the support column 4 and hence of the steering wheel 1 under the force F of an impinging occupant initially occurs about a pivot point situated on the longitudinal axis L of the steering spindle 3 and defined by the gear 22 situated on this longitudinal axis L, the pivot point being fixed by a sufficiently firm, rigid arrangement and design of steering spindle 3 and steering column tube 30. As a result, the transmission arrangement 2 acts as a lever, which initiates the tilting movement of support column 4 and steering wheel 1, in which the steering wheel 1 moves towards the sleeve 32. (In this process the hub 15, gear 22 and sleeve 31 form a type of “ternaryjoint”). As the movement progresses, the hub 15 and the gear 22 then disengage due, for example, to a deformation of the toothed areas 21, 23 as a result of the crash induced forces F or corresponding torsional forces, in order to permit the desired movement and deformation of the mount 4. At the same time the housing 20 of the transmission arrangement 2 is destroyed.

In FIG. 1, the plane E lying perpendicular to the vehicle longitudinal direction x and into which the steering wheel rim 11 is shifted by a combined tilting and shortening of the support column 4, is indicated by dashed line. It can be seen that owing to the combined shortening and tilting of the support column 4, the steering wheel rim 4 and hence also the airbag module 7 have on the one hand been distanced from the body of an occupant (driver) situated behind the steering wheel 1, and that the steering wheel rim 11 and the cover 71 of the airbag module 7 now lie in a plane E, which lies essentially perpendicular to the vehicle longitudinal direction x and thereby essentially parallel to the upper body of an occupant sitting upright.

The compression or shortening of the support column 4 cushions the impact of an occupant against the deploying airbag 73. Owing to the simultaneous tilting of the steering wheel 1 and hence also of the airbag module 7 into a perpendicular position, the airbag 73 deploys out of the module housing essentially in the vehicle longitudinal direction x. As a result, the main direction of deployment of the airbag 73 (in the vehicle longitudinal direction x) is adjusted to the direction of movement of the impinging occupant, who in a head-on collision essentially moves in precisely the opposite direction to the main direction of deployment of the airbag 73. The interaction of the occupant with the airbag is thereby optimized from the biomechanical standpoint.

Also of importance for the present invention is the fact that, due to the arrangement of the steering shaft or steering spindle 3 outside the axis of rotation A (which is defined by the support column 4), the steering spindle 3 does not adversely affect the tilting and shortening of the support column 4.

The steering wheel 1 and the airbag module 7 can therefore be brought into their desired final position by a suitable, defined tilting and shortening of the support column 4, unimpeded by the steering spindle 3.

As an alternative to the weakened area 43 in the second section 42 of the support column 4 provided for in FIG. 1, a shortening of the support column 4 might also be brought about, for example, through displacement of the support column 4 on the steering column tube 30 in a direction away from the occupant. For this purpose the connection between the sleeve 31 supported on the steering column tube 30 and the steering column tube 30 would have to be designed in such a way that it is released when a vehicle occupant impinges on the steering wheel 1 or on the deploying airbag 73 and permits a displacement of the sleeve 31 and thereby of the support column 4 along the steering column tube 30. This also shortens the effective length of the support column 4, since the support column 4 is telescopically displaceable on the steering column tube 30.

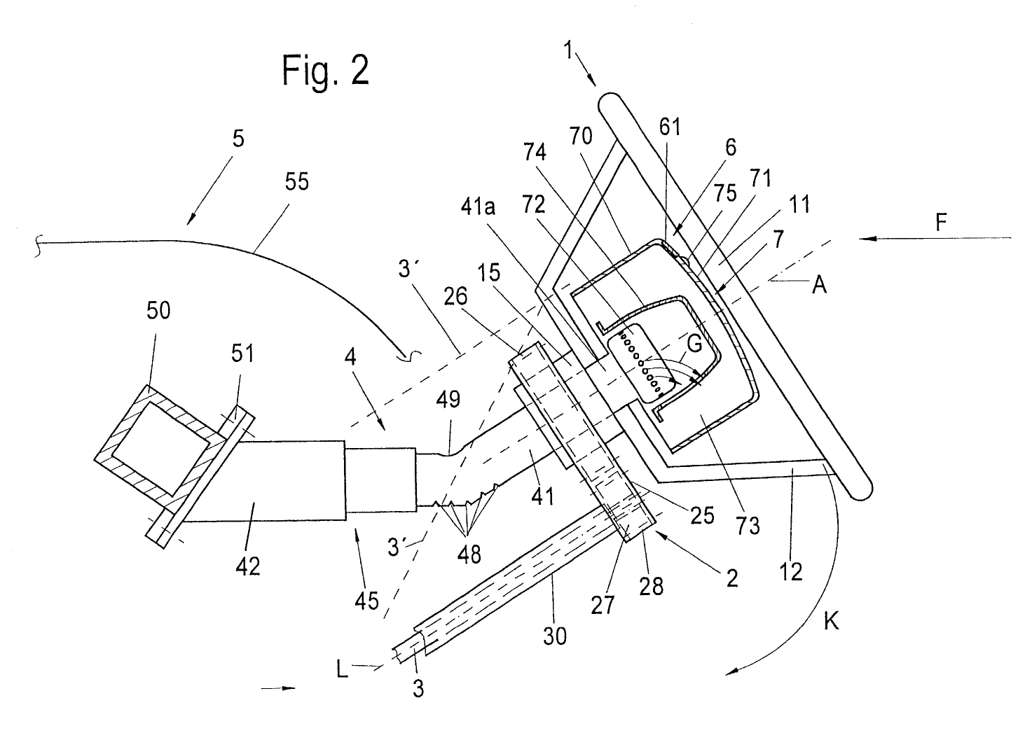

In another exemplary embodiment of the invention represented in FIG. 2 the support column 4 is telescopic. In particular, the second section 42 of the support column is telescopic, therefore forming a telescopic device 45. In this embodiment, the tilting of the support column 4 is facilitated by a plurality of notches 48.

In order that the telescopic device 45 becomes operative only once a defined force (impact of a vehicle occupant) is exerted on the steering wheel 1 or the airbag module 7, a fluid or other means (elastic elements, for example), which counteract a shortening of the support column 4 and can be overcome only by a pre-determinable minimum force, may be provided in the telescopic device 45.

A further difference between the exemplary embodiment of FIG. 2 and the steering device represented in FIG. 1 is that the support column 4 of FIG. 2 is fixed by means of a flange 51 to a cross-member 50 of the vehicle structure 5 running in the area of the dashboard 55.

Furthermore, of FIG. 2 an endless member in the form of a plastic toothed belt 25, which is driven by an external toothing 26 of the steering wheel hub 15, serves to transmit the rotational movement of the steering wheel 1 to the steering shaft or steering spindle 3. For this purpose the toothed belt 25 engages with the external toothing 28 of a gear 27 arranged concentrically on and rotationally fixed to the steering spindle 3.

Coupling the steering wheel 1 to the steering spindle 3 by way of a toothed belt 25 has the advantage that a crash-induced movement of the support column 4 in relation to the steering spindle 3 can thereby easily be compensated for, if the toothed belt 25 slips off the assigned transmission elements 15, 27 owing to the forces F acting in the event of a crash.

Furthermore, the use of such a toothed belt 25 permits great flexibility with regard to the spatial arrangement of the steering spindle 3 on the one hand and the support column 4 on the other. A number of different arrangements of the steering spindle 3 in relation to the support column 4 are represented by dashed lines in FIG. 1, the dashed lines identified by 3′ each denoting possible alternative arrangements of the steering spindle 3 or of its longitudinal axis L.

In this instance the support column 4 is arranged in relation to the steering spindle 3 in such a way that the desired tilting movement K of the steering wheel 1 cannot occur about the gear 27 supported on the steering spindle 3 as pivot point. The arrangement of steering spindle 3 and support column 4 chosen here would rather impede the desired tilting movement. Means must therefore be provided, which in a crash will permit deflection of the steering spindle 3 (by tiling down, for example), in order to allow the desired movement of the support column 4.

The problem described above might also be overcome by arranging the steering spindle along a line 3′ indicated by a dashed line in FIG. 2, where space in the relevant vehicle permits. The arrangement of steering spindle 3 and support column 4 would then essentially correspond to that shown in FIG. 1.

The exemplary embodiment of FIG. 2 otherwise matches the exemplary embodiment of FIG. 1, so that for other details reference may be made to the descriptions above.

Germany Priority Application 100 59 928.1, filed Nov. 23, 2000 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An apparatus for steering a motor vehicle, comprising:
a rotatable steering device having an axis of rotation;
a transmission mechanism for translating a rotational movement of the steering device into a movement of a steering element positioned away from the axis of rotation of the steering element, and
a mount fastened to the motor vehicle for supporting the steering element, wherein the mount includes a portion extending in a direction parallel to the axis of rotation of the steering element;
wherein the mount is configured to cushion the impact of the occupant against the steering element.

2. The apparatus of claim 1, the extending portion of the mount is configured to tilt downward in the event that the occupant impacts the steering device.

3. The apparatus of claim 2, wherein the mount is configured so that when the occupant impacts the steering device the extending portion tilts so that it extends in a direction substantially parallel to the longitudinal direction of the vehicle.

4. The apparatus of claim 2, wherein the mount is configured to pivot about an axis when tilting downward.

5. The apparatus of claim 2, wherein the mount is configured to bend when tilting downward.

6. The apparatus of claim 5, wherein the mount includes a deformable section to facilitate bending.

7. The apparatus of claim 5, wherein the mount includes a weakened area positioned to facilitate the downward tilting of the mount.

8. The apparatus of claim 7, wherein the weakened area comprises a notch.

9. The apparatus of claim 1, wherein the mount is configured to shorten in length in order to cushion the impact of the occupant against the steering device.

10. The apparatus of claim 9, wherein the mount includes a weakened area, in order to facilitate the shortening in length.

11. The apparatus of claim 9, wherein the mount is telescopic.

12. The apparatus of claim 11, wherein the mount includes a means for resisting the telescopic shortening of the length mount.

13. The apparatus of claim 12, wherein the means comprises a fluid.

14. The apparatus of claim 12, wherein the means is elastic.

15. The apparatus of claim 1, wherein the mount includes a support column.

16. The apparatus of claim 1, further comprising a fixed sub-assembly having a non-steering function attached to portion of the mount extending in a direction parallel to the axis of rotation of the steering device.

17. The apparatus of claim 16, wherein the fixed sub-assembly comprises a safety device for the protection of an occupant in the event of an impact.

18. The apparatus of claim 16, wherein the fixed sub-assembly comprises electrical functional assemblies of the motor vehicle.

19. The apparatus of claim 17, wherein the safety device includes an airbag module.

20. The apparatus of claim 19, wherein the airbag module is of asymmetrical design in relation to the axis of rotation of the steering device.

21. The apparatus of claim 17, wherein the airbag module includes an inflatable airbag folded asymmetrically in relation to the axis of rotation of the steering device.

22. The apparatus of claim 1, further comprising a fixed cladding surrounding the steering device, wherein the mount is fixed to the cladding.

23. The apparatus of claim 1, wherein the mount is configured to be attached to a cross-member of the vehicle in an area of the vehicle dashboard.

24. The apparatus of one of claim 1, wherein the steering device includes a steering shaft.

25. The apparatus of one claim 1, wherein the transmission mechanism includes toothed gearing.

26. The apparatus of claim 1, wherein the transmission mechanism includes an endless member for transmitting rotational movement of the steering device to the steering element.

27. The apparatus of claim 15, wherein the steering element has a longitudinal axis and the support column is positioned so that in the event of an impact of a vehicle occupant the steering device tilts about a portion of the transmission mechanism arranged on the longitudinal axis of the steering element.

28. The apparatus of claim 26, wherein the transmission arrangement acts as a lever, which extends from the longitudinal axis of the elongate steering element to the axis of rotation of the steering device.

29. The apparatus of claim 27, wherein the transmission mechanism can be disengaged from the steering device and the steering element by forces acting on the steering device in the event of an impact of a vehicle occupant.

30. The apparatus of claim 2, wherein the transmission mechanism is arranged in a housing configured to be damaged by the tilting of the mount.

31. The apparatus of claim 9, wherein the transmission mechanism is arranged in a housing configured to be damaged by the compression of the mount.

32. The apparatus of claim 29, wherein the housing includes a predefined breaking point.

33. The apparatus of claim 1, wherein the steering device and the transmission mechanism are designed as a pre-assembled module, which can be connected to the steering element.

34. The apparatus of claim 1, wherein the steering device includes a steering wheel.
